(19) United States
(12) Patent Application Publication
(10) Pub. No.: US 2009/0235108 A1
(43) Pub. Date: Sep. 17, 2009

(54) AUTOMATIC PROCESSOR OVERCLOCKING

(76) Inventors: Spencer M. Gold, Pepperell, MA (US); Alex Branover, Brookline, MA (US); Hanwoo Cho, Acton, MA (US); Sebastien Nussbaum, Lexington, MA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 12/045,916

(22) Filed: Mar. 11, 2008

(51) Int. Cl. G06F 1/00

(52) U.S. Cl. 713/500

(57) ABSTRACT

Processor overclocking techniques are disclosed. Upon automatically determining that overclocking entry criteria are satisfied, one or more cores are clocked above their standard operation frequencies. The cores may be overclocked until one or more exit criteria are satisfied. At that point, an exit procedure is performed, with the one or more overclocked cores return to their normal operating frequency.

### BACKGROUND OF THE INVENTION

1. Field of the Invention

This invention relates generally to the field of microprocessors, and specifically to overclocking of processing elements including processing cores in multi-core devices.

2. Description of the Related Art

Frequently, it is desired to increase the performance of a computer system through the use of “overclocking.” By design, a manufacture establishes a default clock rate based on the physical limitations of a processing unit. This standard clock rate provides a consistent time period used throughout the processor unit and determines the rate that operations are performed. Past uses of overclocking have involved manually increasing the clock frequency above this default clock rate in response to explicit user input.

### SUMMARY

Various embodiments for performing overclocking for a plurality of processing units are disclosed. In one embodiment, an apparatus includes a plurality of processing cores (each of which has a respective standard operating frequency); a clock generation unit coupled to each of the plurality of processing cores, where the clock generation unit is configured to generate a respective clock signal for each of the plurality of processing cores; and a performance control unit coupled to the clock generation unit and configured to receive current state information indicative of the state of the apparatus. In response to the received state information satisfying a first set of entry criteria, the performance control unit is configured to cause the clock generation unit to increase, for each of a first set of one or more of the plurality of processing cores, the frequency of the respective clock signal above its standard operating frequency. The performance control unit is further configured, in response to the received state information subsequently satisfying a second set of exit criteria, to cause the clock generation unit to return the frequency of the clock signal for each of the first set of processing cores to its standard operating frequency.

In some embodiments, the state information may contain performance or thermal information corresponding to various utilization, temperature, and power entry/exit criteria. In one embodiment, these criteria may include waiting for an amount of time before beginning or discontinuing overclocking. This wait time may be a predetermined amount, or based on a moving average. In another embodiment, the state information may include utilization criteria corresponding to a workload value or performance state information of one or more of the processing cores. In other embodiments, the state information may include temperature criteria corresponding to a maximum overclocking temperature or a composite score indicative of thermal operating characteristics. In further embodiments, the state information may include power criteria corresponding to a maximum permitted overclocking total power consumption. In one embodiment, the apparatus further comprising a cooling subsystem configured to cool one or more of the plurality of processing cores, wherein the performance control unit is configured to vary the operation of a cooling device in the cooling subsystem in response to the received state information satisfying at least one of the first or second sets of criteria.

Various embodiments include systems and methods for performing techniques disclosed herein.

### BRIEF DESCRIPTION OF THE DRAWINGS

FIG. 1 is a block diagram of one embodiment of a computer system for performing overclocking.

FIG. 2 is a block diagram of one embodiment of a processing unit containing a plurality of processing cores.

FIG. 3 is a flowchart of one embodiment of a method for overclocking a processing unit.

FIG. 4 is a flowchart of one embodiment of a method for evaluating overclocking entry conditions and performing an overclocking entry procedure.

FIG. 5A depicts an exemplary table of performance states.

FIG. 5B depicts an example of overclocking of a processing unit.

FIG. 6 is a flowchart of one embodiment of a method for discontinuing overclocking of a processing unit.

FIG. 7 depicts an example of discontinuing overclocking of a processing unit.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner in one or more embodiments.

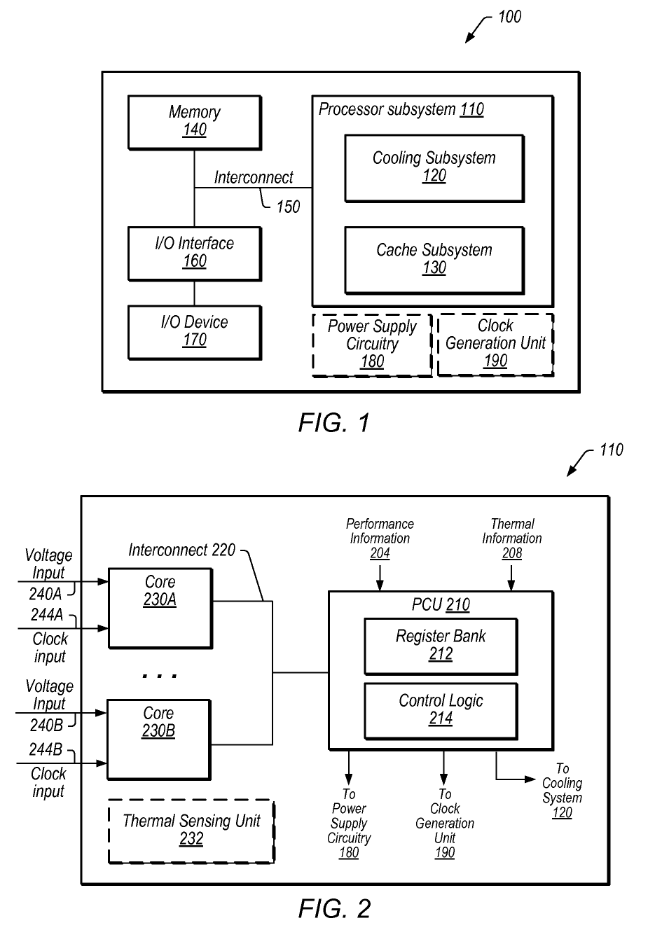

The overclocking algorithm described below may be performed on any suitable type of computer system, which includes any type of computing device. FIG. 1 illustrates one embodiment of a computer system 100 that may be used to implement the below-described techniques. As shown, computer system 100 includes a processor subsystem 110 (which may have a cache subsystem 130 in one embodiment) that is coupled to a memory 140 and I/O interfaces(s) 160 via an interconnect 150 (e.g., a system bus). I/O interface(s) 160 is coupled to one or more I/O devices 170. Computer system 100 may be any of various types of devices, including, but not limited to, a personal computer system, desktop computer, laptop or notebook computer, mainframe computer system, handheld computer, workstation, network computer, a consumer device such as a mobile phone, pager, or personal data assistant (PDA). Computer system 100 may also be any type of networked peripheral device such as storage devices, switches, modems, routers, etc.

Processor subsystem 110 may include one or more processors or processing units. For example, processor subsystem 110 may include one or more processor cores, each with its own internal communication and buses. In various embodiments of computer system 100, multiple instances of processor subsystem 110 may be coupled to interconnect 150. In various embodiments, processor subsystem 110 (or each processing unit within 110) may contain a cache 130 or other form of on-board memory.

In certain embodiments, processor subsystem 110 may be coupled to cooling subsystem 120. When present, cooling subsystem 120 is used to control the temperature(s) of processor subsystem 110. In one embodiment, cooling subsystem 120 may include one or more fans circulating air across processor subsystem 110, while in another embodiment, cooling subsystem 120 may include a liquid circulating system. Cooling subsystem 120 may regulate temperatures only within processor subsystem 110 or may regulate temperatures for the entire computer system 100. (Accordingly, while cooling subsystem 120 is shown logically as being within processor subsystem 110 in FIG. 1, it may be located in any suitable location within system 100.)

Computer system 100 also contains memory 140, which is usable by processor subsystem 110. In various embodiments, memory 140 may include magnetic storage media, such as hard disk storage, floppy disk storage, removable disk storage, etc. Further, memory 140 may include optical storage media, such as a DVD, CDROM, etc. Still further, memory 140 may include volatile and/or non-volatile semiconductor memory such as flash memory, random access memory (RAM-SRAM, EDO RAM, SDRAM, DDR SDRAM, Rambus® RAM, etc.), and read only memory (PROM, EEPROM, etc.).

I/O interfaces 160 may be any of various types of interfaces configured to couple to and communicate with other devices, according to various embodiments. In one embodiment, I/O interface 160 is a bridge chip from a front-side bus to one or more back-side buses.

I/O interfaces 160 may be coupled to one or more I/O devices 170 via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.)

Memory in computer system 100 is not limited to memory 140. Rather, computer system 100 may be said to have a “memory subsystem” that includes various types/locations of memory. For example, the memory subsystem of computer system 100 may, in one embodiment, include memory 140, cache subsystem 130 in processor subsystem 110, storage on I/O Devices 170 (e.g., a hard drive or storage array), etc. Thus, the phrase “memory subsystem” is representative of various types of possible memory media within computer system 100. In some embodiments, memory subsystem 140 includes program instructions executable by processor subsystem 110 to assist in performing overclocking according to the present disclosure.

As shown, system 100 includes power supply circuitry 180, which is adapted to supply power (i.e., voltage) to the various components of system 110. Circuitry 180 may include one or more DC-to-DC converters, which may be programmable. System 100 also includes clock generation unit 190, which may include one or more timing devices used to control the clock frequency sent to various components of system 100. Unit 190 is capable of generating different frequencies for different groups of components in one embodiment, including generating different (independent) frequencies for the various “cores” of processing subsystem 110 described below.

Turning now to FIG. 2, a block diagram of one embodiment of processing subsystem 110 is depicted. As shown, subsystem 110 includes performance control unit (PCU) 210 coupled to cores 230A and B via an interconnect 220. As used herein, the term “core” refers to a processing unit (including, but not limited to, “central” processing units (CPUs)) capable of independently executing computer instructions. (In certain embodiments, each core may also independently implement optimizations including, but not limited to, pipelining, superscalar execution, and multithreading.) A “multi-core” device thus refers to a processing subsystem with two or more processing cores. Although only two cores 230 are illustrated in FIG. 2 for simplicity, additional cores may also be present in other embodiments.

In general, PCU 210 is configured to receive various input information, and automatically determine whether or not to “overclock” one or more of cores 230 based on one or more predetermined sets of (configurable) criteria that correspond to overclocking entry criteria. “Automatic” or “dynamic” determination of overclocking based on predetermined sets of criteria stands in contrast to, for example, overclocking based on an explicit user command to do so. As will be described below, PCU 210 is also configured to automatically determine whether one or more sets of overclocking exit criteria are satisfied, and to discontinue overclocking in response to such a determination, returning clocking of one or more of cores 230 to their respective standard operating frequencies.

When groups of processing units such as cores are manufactured, they are categorized or sorted according to a “standard” operating frequency at which they can run. For example, certain cores may be rated as having a standard operating frequency of 1 GHz, while others may have a standard operating frequency of 1.2 GHz. “Overclocking” refers to the operating a processing unit or core above its standard operating frequency to improve performance.

In one embodiment, PCU 210 is configured to receive performance information 204 and thermal information 208. Performance information 204 is indicative of state information relating to the operating conditions for one or more of cores 230. This information may include, for example, state information such as that specified by the Advanced Configuration and Power Interface (ACPI) standard described further below (e.g., P and C state information). Thermal information 208 relates to thermal characteristics of one or more portions of computer system 110 (in particular, cores 230), and includes such information as temperature and power consumption data. Although information 208 is logically shown as arriving from a source external to subsystem 110, it may also be obtained from, for example, various thermometer circuits within one or more of cores 230.

Control logic 214 within PCU 210 is configured to perform operations relating to overclocking of one or more of cores 230 based at least in part upon information 204, 208, and values in register bank 212 (described further below). In response to this and other information, PCU 210 is configured to generate control signals to one or more of the following units: to power supply circuitry 180 (to control the voltage supplied 240 to cores 230), to clock generation unit 190 (to control the clock frequency 244 to cores 230), and to cooling subsystem 120 in certain embodiments (e.g., to turn on and off a cooling device such as a fan). PCU 210 may also be configured to communicate with cores 230 via interconnect 220. (Thus, if cores 230 include thermal-sensing devices 232, thermal information 208 could be communicated from cores 230 to PCU 210 via interconnect 210.)

Control logic 214 can be any combination of hardware or software. In one embodiment, control logic 214 constitutes combinatorial logic configured to implement a state machine.

In various embodiments, register bank 212 within PCU 210 may contain values associated with performance information 204 and thermal information 208. In other embodiments, register bank 212 may contain additional information that PCU 210 utilizes to perform overclocking. Table 1 depicts one possible embodiment of register bank 212.

TABLE 1
Processor Control Unit Registers

| Register Name | Range | Description |
|---|---|---|
| Therm_in_max[6:0] | 0-127° C. | Maximum allowed temperature for entering overclocking |
| | | mode |
| Therm_out_max[6:0] | 0-127° C. | Temperature threshold for a forced exit of overclocking |
| | | mode |
| Therm_max[6:0] | 0-127° C. | Temperature of the hottest part of a processing die |
| Wait_enter_limit[N:0] | 0-2^{N} cycles | Clock cycle wait period for entering overclocking mode |
| Wait_exit_limit[N:0] | 0-2^{N} cycles | Clock cycle wait period for exiting overclocking mode |
| Wait_count[N:0] | 0-2^{N} cycles | Counter of clock cycles since entering/exiting overclocking |
| | | mode |
| Pstate_in_diff[2:0] | 0-7 P-States | Minimum P-State difference for entering overclocking mode |
| Pstate_exit_diff[2:0] | 0-7 P-States | Minimum P-State difference for exiting overclocking mode |
| Pstate_min[2:0] | 0-7 P-States | P-State separation for cores in the processor |
| Pstate_in_credits[5:0] | 0-31 credits | Maximum P-State credit count for entering overclocking |
| | | mode |
| Pstate_out_credits[5:0] | 0-31 credits | P-State count threshold for a forced exit of overclocking |
| | | mode |
| Pstate_credits[5:0] | 0-31 credits | Total P-State credits for all cores |
| PCU_en | 1 = enabled, | Enable/Disable PCU overclocking |
| | 0 = disabled | |

In certain embodiments, values in these registers may be set in different ways. First, certain values may be scanned in through a test interface (e.g., JTAG). Second, values may be set by fuses that are subsequently “blown” during manufacturing. Third, values may be programmed and then updated (e.g., by ROM, flash programming, etc.)

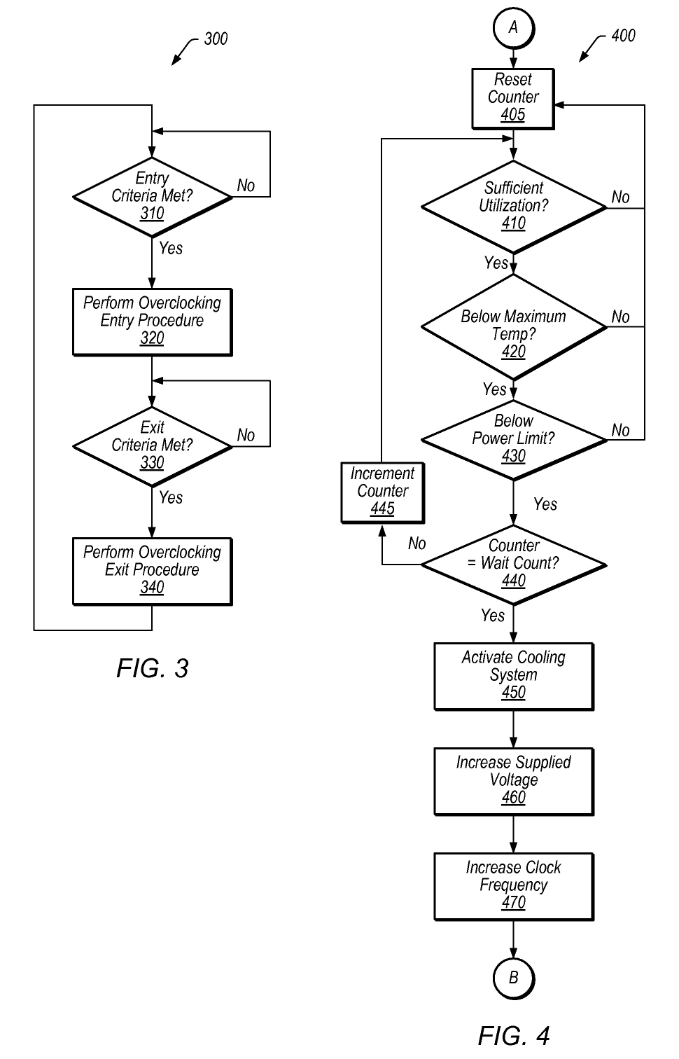

Turning now to FIG. 3, a flowchart of method 300 is shown. Method 300 is one embodiment of a method for automatically overclocking (and discontinuing overclocking) various ones of a plurality of processing cores. Method 300 may be performed by processing subsystem 110 in one embodiment. Accordingly, the following description of method 300 refers to PCU 210. Method 300 may, in certain embodiments, be implemented in hardware as a state machine.

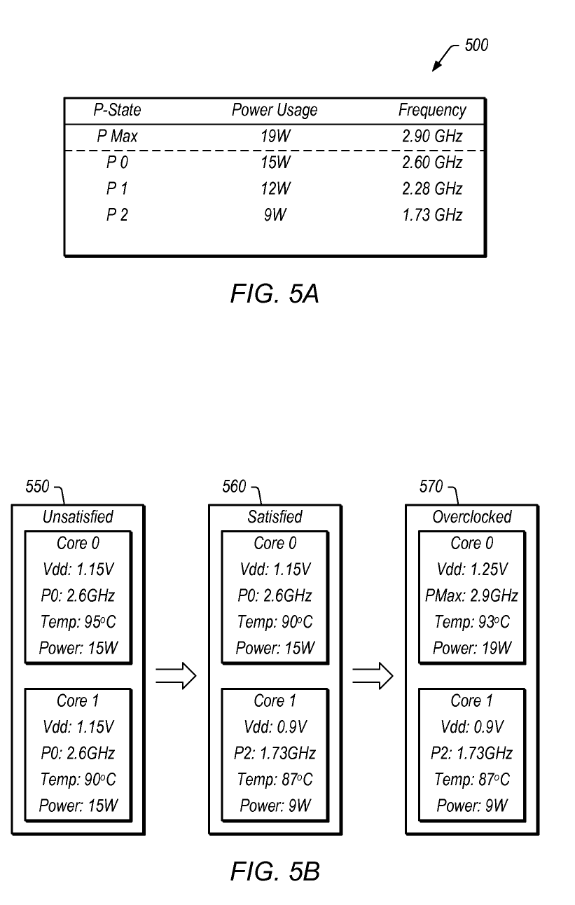

In one embodiment, PCU 210 continually monitors overclocking entry criteria in step 310 to determine if overclocking is warranted. In another embodiment, PCU 210 monitors only when enabled or some enabling criteria is satisfied (in one embodiment, PCU 210 is always enabled). The overclocking entry criteria may be any set of criteria, and can include various logical operators. For example, the entry criteria may be of the form A AND B AND C AND D (such that all of A, B, C, and D must be true), A OR B OR C OR D, (A or B) AND C AND NOT D, etc. These criteria may be applied separately for each of the cores in certain embodiments. Similarly, “test conditions” that are included within the entry criteria may be based on various types of information. In one embodiment, for example, the test conditions may be based on the following types of information: performance state information (e.g., that received from an operating system of the computer system), thermal information (e.g., temperature, power, etc.) received from thermal-sensing devices within the computer system. (For example, one or more thermometers may be located in each of the plurality of processing cores. When the entry criteria are satisfied, PCU 210 initiates in step 320 an overclocking entry procedure for the cores indicated in step 310. In general, the entry procedure is a set of steps to be taken before or as part of effectuating overclocking of one or more cores. In one embodiment the entry procedure may include continually monitoring entry conditions to ensure that they are satisfied for a predetermined period of time. The use of this “wait time” may prevent a core from quickly shifting in and out of overclocking (referred to as “thrashing”). Once this procedure is complete, the one or more cores are now running in an overclocked mode. Embodiments of the entry conditions and the entry procedure are described in greater detail below in conjunction with FIGS. 4, 5A, and 5B.

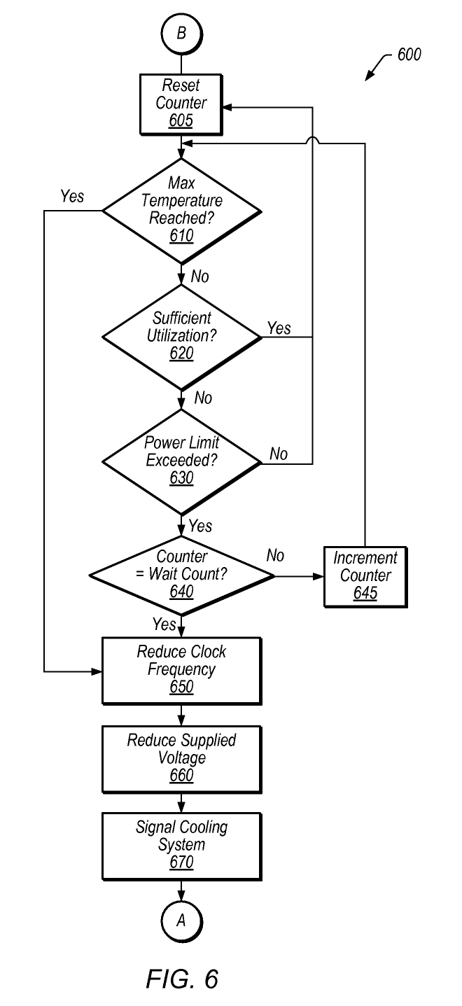

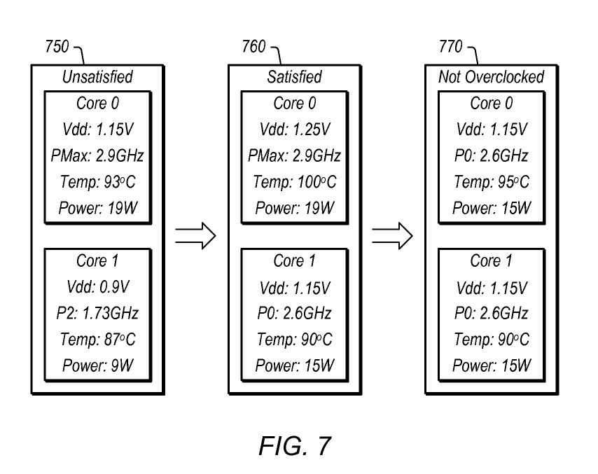

While overclocking is being performed, PCU 210, in one embodiment, continually monitors exit criteria in step 330 to determine whether overclocking should be discontinued. As with the entry criteria, the entry criteria can include any logical operators and types of test conditions. If the exit criteria are satisfied (either in general or for any of the overclocked cores, depending on how the exit criteria are defined), PCU 210 performs an exit procedure in step 340 to effectuate discontinuation of overclocking. (Note that overclocking may be discontinued for one core, but one or more other cores may remain overclocked in certain embodiments.) Once no cores are being overclocked, method 300 returns to step 310 in which the entry conditions are checked. The exit conditions and exit procedure are described in greater detail below in conjunction with FIGS. 6 and 7.

Turning now to FIG. 4, a flowchart of method 400 is shown. Method 400 is one specific embodiment of an algorithm for implementing steps 310 and 320 of method 300. To simplify explanation, method 400 is described on a per-processing unit basis, and is further described in conjunction with an exemplary situation illustrated in FIGS. 5A and 5B.

In optional step 405, a wait counter is reset to an initial value. This wait counter is usable to eliminate or reduce thrashing by processor units in and out of overclocking. In the embodiment shown in FIG. 4, the wait counter is used to ensure that entry conditions 410, 420, and 430 are met for some length of time (the “wait count” in FIG. 4) before beginning overclocking. In one embodiment, this length of time is fixed or hard coded (e.g., some predetermined number of cycles). In other embodiments, this length of time is configurable based on a register value. In still other embodiments, this wait time is computed based upon a “moving average.” Thus, if thrashing occurs frequently using a certain wait time, the overclocking entry wait time may be adjusted by incremental amounts based on previously attempted wait times until thrashing no longer occurs.

In step 410, a determination is made whether a particular processing unit has sufficient utilization to merit overclocking. If a processing unit or core is not sufficiently “busy,” it may not be desirable to overclock that processing unit in one embodiment. Accordingly, “utilization” in step 410 refers to any of various metrics for determining whether a processing unit is sufficiently “in demand”—for example, determining a requirement for a processing unit's computational workload, such as whether the operating system is adjusting or throttling a processing unit because its current computational workload is not very demanding. In one embodiment, this determination may include analyzing information provided by an operating system such as a percentage of CPU usage, the time that a processing unit spends between executing instructions and idling, or the number or type of scheduled processes/threads. In another embodiment, the determination may include analyzing information provided by the processing units themselves, including, but not limited to, the type of executing instructions or the frequency of certain interrupts. In other embodiments, the determination may include assessing performance states of the processing unit cores. In any event, if sufficient utilization for the particular processing unit is found to exist in step 410, method 400 continues to step 420; otherwise it returns to step 405, wherein the counter value is reset.

Performance states may be assigned to each processing core by an operating system based on a variety of factors, including a core's usage load. The performance states may conform, for example, to the Advanced Configuration and Power Interface (ACPI) specification or any future industry standards. One simplified example of the use of such performance states is shown in FIG. 5A. In example 500 shown here, each performance state (“P-State”) has a corresponding input voltage and clock frequency (e.g., a processing core running in P-state P0 has an input voltage of 1.15 V and operates at 2.60 GHz). In this example, performance states P0-P2 represent non-overclocked states. It is noted that the lower performance state numbers correspond to higher performance levels (conversely, the higher performance state numbers correspond to lower performance levels—thus, a processing core operating at P-State P0 is at a higher performance level than a processing core operating at P2). The value PMax, on the other hand, represents an overclocked processing state. Additionally, the designation PHigh is used to connote the highest performance state that the operating system is “aware” of. In embodiments in which the overclocking of processing units is visible to the OS, PHigh may correspond to PMax. In embodiments in which the OS is not aware that a processing unit is overclocked, PHigh may correspond to the highest non-overclocked performance state (e.g., P0 under the ACPI standard). Thus, certain overclocking entry and exit conditions described below are based in part on the value PHigh.

A variety of criteria based on performance states may be used to determine whether sufficient utilization exists. In one embodiment, a processing core may be required to be operating in state P0 before overclocking is permitted. In another embodiment, multiple cores may be required to be operating under state P0. Other criteria are, of course, possible.

In step 420, it is determined whether a processing core is sufficiently below its maximum operating temperature. By design, a processor core has a maximum permitted temperature that cannot be exceeded without risking damage to the core. When overclocking is performed, additional power is needed to accommodate for the faster clock rate, resulting in the generation of more heat. Thus, in this embodiment, the idea is that a processing core must be sufficiently below its maximum operating temperature so that when it undergoes overclocking, it can remain overclocked for an ample amount of time (e.g., to avoid thrashing).

Multiple techniques for assessing a processing core's thermal characteristics may be used. In one embodiment, this determination may include measuring an average temperature for an entire core and comparing it to a maximum permitted average. In another embodiment, the determination may include measuring specific “hot spots” in a core (e.g., a branch-prediction unit) and specifying limits for each of the measured locations.

When thermal sensing devices (e.g., thermal sensing unit 232) collect temperature and other thermal information (e.g., power consumption), this information may be stored in register bank 212 for later use by PCU 210. In one embodiment, the register Therm_max[6:0] listed in Table 1 above contains a maximum temperature measured from a core. PCU 210 may subsequently compare the value in Therm_max[6:0] against a maximum permitted limit (e.g., a value stored in therm_in_max[6:0]). For example, if Therm_max[6:0] is less than therm_in_max[6:0], the core is below the maximum entry temperature for overclocking and method 400 proceeds to step 430. Otherwise, method 400 returns to step 405.

In step 430, a determination is made whether the processing unit being checked for overclocking is below a predetermined upper power limit. In one embodiment, this determination may include measuring the power consumed by each core and determining a total permitted amount of power consumption, while in another embodiment, this determination may include calculating power consumed by the entire computing device. In any event, if the power criteria of step 430 are satisfied, method 400 proceeds to step 440; otherwise, it returns to step 405.

In yet another embodiment, performance states may be used as a “proxy” for power information. Since each P-State has a corresponding power level (described above; see also FIG. 5A), a PCU such as PCU 210 may use the current P-States for each processing core to determine (or estimate) power demands in various embodiments. In one embodiment, a minimum separation of performance states for each of the cores is maintained to ensure that power demands are never exceeded. As illustrated in the example of FIG. 5A, if a processing subsystem containing two cores is not allowed to consume more than 25 watts of power and one core is operating in PMax, the other core must, under this criteria, be operating in power state P2. Thus, if a core is operating at P0 and it is candidate for overclocking (i.e., changing from P0 to PMax), the other core, in this example, must be operating at P2 prior to overclocking the candidate core, otherwise power limits would be exceeded when the candidate core began operating at PMax. Therefore, if the value “2” is stored in register Pstate_in_diff[2:0] in register bank 212, this indicates that the two cores must have a separation of two P-states for the core with the higher P-State to be a candidate for overclocking. By comparing Pstate_min[2:0] against a permitted P-State separation value stored in Pstate_in_diff[2:0], PCU 210 may determine whether processing subsystem 110 will exceed its power limitations when overclocking is performed on one of its cores. It is noted that, in other embodiments where overclocking of processing units is not visible to the OS (i.e., PHigh corresponds to P0), the P-State separation value in this example may be different.

In another embodiment using P-States, a “credit-scoring” algorithm may be used if several processing cores exist (for example, when there are four or more cores). When such an algorithm is used, P-States may be assigned a credit value (e.g., PMax=4 credits, P0=3 credits, P1=1 credit, and P2=0 credits), where the credit values are indicative of thermal usage characteristics of the various cores. Then, a formula may be used to determine a P-State credit total. In one embodiment, such a formula may simply be a summation of the various credit values. For example, a processing unit with core 0 at PMax, core 1 at P1, and core 2 at P2 has a score of 5 (i.e. 4+1+0). In other embodiments, formulas may include weighted or time-based averages as well as various other techniques.

In example register bank 212 described above, Pstate_credits[5:0] may contain a credit total for processing subsystem 110 and Pstate_in_credits[5:0] may contain a maximum number of credits allowable for performing overclocking. Thus, PCU 210 compares Pstate_credits[5:0] against Pstate_in_credits[5:0] in one embodiment of step 440. In one embodiment, if Pstate_credits [5:0] is less than Pstate_in_credits, the power criteria are satisfied for overclocking.

In step 440, the current value of the counter is checked to determine if it is equal to the desired wait count (which can be set any number of ways, as described above). If the counter is not equal to the wait count, method 400 proceeds to step 450, wherein the counter is incremented and method 400 returns to step 410. Accordingly, all entry criteria (in this example, steps 410, 420, 430) must continue to be satisfied until the counter equals the wait count. If the counter does equal the wait count, method 440 continues to step 450 in one embodiment.

In one embodiment that utilizes register bank 212, Wait_count[N:0] serves as a counter containing the number of clock cycles that have transpired since entering/exiting conditions were initially satisfied for overclocking mode, and Wait_enter_limit[N:0] is the required wait time before overclocking is permitted. In such an embodiment, PCU 210 may compare Wait_count[N:0] against a minimum entry wait period stored in Wait_enter_limit[N:0] to determine whether ample time has passed before commencing overclocking. In other embodiments, steps 405, 440, and 445 are optional (i.e., a “wait count” is not used).

Steps 410-440 correspond to one or more possible entry conditions that collectively make up entry criteria for performing overclocking. In other embodiments, other conditions may be checked. It is further noted that steps 410-440 may be performed individually, simultaneously, or in any particular order. As noted above, these entry criteria, permit computer system 100 (and, more particularly, PCU 210) to automatically determine when it is appropriate to overclock one or more processing units, permitting “on-the-fly” overclocking that allows computer system 100 to quickly adapt to current conditions. In one embodiment, PCU 210 may use a logical formula for determining whether to overclock one or more cores. One such formula for a two-core processor that uses registers depicted in Table 1 is presented below. This formula checks five criteria 1) whether a core is running at a maximum non-overclocked state, 2) whether a measured temperature is below a maximum threshold, 3) whether a minimum P-State separation exists between cores, 4) whether entry conditions have been continually met for the desired wait count, and 5) whether overclocking is enabled (similar formulas apply to embodiments with more than two cores).

PCU Entry=(P-State of Core0==P0|P-State of Core1==P0)& Therm_max[6:0]<=Therm_in_max[6:0] & Pstate_min[2:0]>Pstate_in_diff[2:0] & Wait_count[N:0]>Wait_enter_limit[N:0] & PCU_en==1.

Another such formula for a two-core processor that uses P-State credits is presented below. This formula is similar to the one above, except that it checks P-State credits instead of checking that a minimum P-State separation exists. This formula may be adapted for use with a larger numbers of cores.

PCU Entry=(P-State of Core0==P0|P-State of Core1==P0)& Therm_max[6:0]<=Therm_in_max[6:0] & Pstate_Credits[5:0]<Pstate_in_credits[5:0] & Wait_count[N:0]>Wait_enter_limit[N:0] & PCU_en==1.

Once the entry criteria for overclocking a particular core are satisfied, the cooling system of the core is preemptively activated in optional step 450 to prepare for the increasing temperatures created by overclocking. Then, the voltage supplied to the core and clock frequencies are increased in steps 460 and 470. These steps may be performed, in certain embodiments, via control information sent to power supply circuitry 180 and clock generation unit 190, respectively. At this point, the core is now overclocked.

In one embodiment, the overclocking entry procedure may include disabling precautionary countermeasures that protect a processor from over heating. As mentioned above, a processor core is typically rated with a maximum permitted temperature that cannot be exceeded without risking damage to the core. To prevent a core from overheating, a processor may include a hardware throttling control system that aggressively reduces or even stops the clock of a processing core once thermal limitations are exceeded. Since PCU 210 also monitors thermal conditions (e.g., in steps 420 and step 610 (described below)), it may choose to disable a throttling control system in one embodiments that include such hardware

Turning now to FIG. 5B, an example of a processing unit implementing method 400 is shown. In this example, the entry conditions specify that a core must be operating in performance state P0, be below 91° C., and the total combined power consumption for all cores is less than 25 W. In example 550, these conditions are not satisfied, as core 0 has a temperature of 95° C. and the total combined power usage is 30 W. In example 560, however, core 0 is eligible for overclocking. In example 570, core 0 is shown as being overclocked, as core 0 is operating under PMax at 2.9 GHz with an input voltage of 1.25 V.

Turning now to FIG. 6, a flow chart of method 600 for discontinuing overclocking one or more cores within processor subsystem 110 is shown. Method 600 is one specific embodiment of an algorithm for implementing steps 330 and 340 described above (many other embodiments are also possible). Method 600 is also described below in conjunction with an exemplary situation illustrated in FIG. 7.

As mentioned above, it is undesirable for processing cores to rapidly oscillate into and out of an overclocked mode. To prevent such thrashing, exit conditions for a processing core may, in some embodiments, be required to be satisfied for some period of time (a “wait count” analogous to the wait count described above for entering overclocking) before discontinuing overclocking. For example, in step 605, a counter is reset—this counter represents the time since exit conditions were initially satisfied, and is subsequently compared to the wait count in step 640.

In step 610, a determination is made whether a processing core is sufficiently below its maximum operating temperature. As in step 420, one or more temperatures or thermal characteristics are monitored to ensure that overclocked cores are not overheating. In one embodiment, if a PCU such as PCU 210 determines that an overclocked core has reached or exceeded this predetermined temperature limit, PCU 210 initiates an exit procedure (i.e., it proceeds directly to steps 650-670). In the embodiment shown in FIG. 6, upon detecting a maximum thermal condition, overclocking is discontinued without waiting to determine whether other exit conditions are satisfied (e.g., conditions set by steps 620 and 630). Thus, in the embodiment of FIG. 6, there are two sets of exit conditions: 1) whether the maximum temperature has been reached and 2) if not 1, whether the processing unit is below its maximum temperature, insufficiently utilized and above its power limit for a time period equal to the wait count of step 640.

In step 620, a determination is made whether a processing core has sufficient utilization to sustain overclocking. (In many instances, it may not make sense to continue overclocking where sufficient utilization does not exist, even if thermal maximums have not been reached.) In one embodiment, overclocked cores are checked to verify that P-States remain at performance state PHigh. If PCU 210 determines that an operating system has changed a core's P-State, PCU 210 proceeds to step 640 described below. In various embodiments, the determination may include similar techniques to those described above in step 410.

In step 630, a determination is made whether a processing core exceeds a predetermined power limit. In one embodiment, a minimum P-State separation may be maintained in a similar manner as described in step 430. In another embodiment, a P-State scoring algorithm may be used. This determination may include other techniques similar to those described above in step 430.

In step 640, the wait counter, reset in step 605 is checked to ensure that exit conditions are continually met for an appropriate time period. If enough time has passed, method 600 proceeds to step 650. Otherwise, method 600 proceeds to step 645 where the counter value is incremented. As with the entry wait count, the exit wait count may be set in several different ways. For example, as with the entry wait count, the exit wait count may be determined from a calculated moving average based on previous overclocking information.

In one embodiment, steps 605, 640, and 645 are optional.

Steps 610-640 correspond to one or more possible exit conditions that may be checked during overclocking. In other embodiments, many other combinations of conditions may be checked, such as a maximum permitted time period for overclocking a core, changing power supply information (e.g., the remaining battery life of an overclocking system), etc. It is noted that steps 610-640 may be performed individually, simultaneously, or in any particular order. In one embodiment, PCU 210 may use a logical formula for determining whether to discontinue overclocking one or more cores. One such formula for a two-core processor that uses registers depicted in Table 1 is presented below. This formula checks four criteria 1) whether a measured temperature is below a maximum threshold, 2) whether a core is running at a PHigh state, 3) whether a minimum P-State separation exists between cores, 4) whether ample wait time has passed from previous overclockings.

PCU Exit=Therm_max[6:0]>Therm_out_max[6:0]|(((P-State of Core0!=PHigh & P-State of Core1!=PHigh) Pstate_min[2:0]<Pstate_out_diff[2:0]) & Wait_count[N:0]>Wait_exit_limit[N:0]).

Another such formula for a two-core processor that uses P-State credits is presented below. This formula may be expanded to a larger number of cores.

PCU Exit=Therm_max[6:0]>Therm_out_max[6:0]|(((P-State of Core0!=PHigh & P-State of Core1!=PHigh)|Pstate_Credits[5:0]>Pstate_out credits[5:0]) & Wait_count[N:0]>Wait_exit_limit[N:0]).

In the above entry and exit formulas, ‘&’ AND and ‘|’ OR logical operations are used to represent combinations of criteria. In the entry and exit formulas given above, the entry formulas use only ANDs, which require all conditions to be satisfied before the logical statement is true, while the exit formulas use mostly ORs, which require only some of the conditions to be satisfied before the logical statement is true. In other embodiments, other combinations of ANDs and ORs may be used in the entry and exit criteria.

Once the specified conditions for exiting overclocking are satisfied, the exiting procedure is performed. First, in step 650, the clock frequency of the core is reduced. Next, the voltage supplied to the core is reduced in step 660. Finally, in optional step 670, the cooling system is notified that overclocking is no longer being performed. Once method 600 is complete and a core is no longer being overclocked, method 400 returns to step 410 and resumes monitoring for overclocking criteria.

Turning now to FIG. 7, an example of a processing unit implementing method 600 is shown. In this example, processing cores must be separated by at least two performance states, operate below 100° C., and consume less than 30 W of power in aggregate. As illustrated, the processing unit in example 750 fails to satisfy any of the required exit conditions, as the cores are separated by three performance states, no cores reach 100° C., and the cores collectively consume only 28 W. In example 760, however, the processing subsystem satisfies all three exiting conditions (e.g., the cores are separated by only one performance state, core 0 has reached 100° C., and the cores consume 34 W). Because the process subsystem satisfies at least one of the conditions in state 760 (in fact, it satisfies all conditions), the processing subsystem discontinues overclocking of core 0 in example 770. It is noted that in other embodiments where overclocking of processing units is not visible to the operating system (i.e., PHigh corresponds to P0), the P-State separation value may differ.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a plurality of processing cores, each of which has a respective standard operating frequency;
a clock generation unit coupled to each of the plurality of processing cores, wherein the clock generation unit is configured to generate a respective clock signal for each of the plurality of processing cores;
a performance control unit coupled to the clock generation unit and configured to receive current state information indicative of the state of the apparatus;
wherein, in response to the received state information satisfying a first set of entry criteria, the performance control unit is configured to cause the clock generation unit to increase, for each of a first set of one or more of the plurality of processing cores, the frequency of the respective clock signal above its standard operating frequency;
and wherein the performance control unit is further configured, in response to the received state information subsequently satisfying a second set of exit criteria, to cause the clock generation unit to return the frequency of the clock signal for each of the first set of processing cores to its standard operating frequency.

2. The apparatus of claim 1, further comprising a cooling subsystem configured to cool one or more of the plurality of processing cores, wherein the performance control unit is configured to vary the operation of a cooling device in the cooling subsystem in response to the received state information satisfying at least one of the first or second sets of criteria.

3. The apparatus of claim 1, further comprising a thermal-sensing device configured to measure thermal characteristics of one or more of the plurality of processing cores, wherein the received state information includes information generated by the thermal-sensing device.

4. The apparatus of claim 1, wherein received state information is indicative of the total amount of power consumed by all of the processing cores.

5. A method, comprising:
automatically determining that overclocking entry criteria are satisfied in a multi-core processing device;
in response to determining that the overclocking entry criteria are satisfied, overclocking one or more of the cores in the device;
automatically determining that overclocking exit criteria are satisfied in the multi-core processing device;
discontinuing said overclocking in response to determining that the overclocking exit criteria are satisfied.

6. The method of claim 5, wherein said determining that the overclocking entry criteria are satisfied includes determining a work load value for each of the cores, generating a composite score from the work load values, and comparing the composite score to a threshold work load value.

7. The method of claim 6, wherein the device includes at least four cores.

8. The method of claim 5, wherein said overclocking is not performed for a first core in the device if the first core is at a temperature greater then a specified maximum overclocking temperature.

9. The method of claim 5 further comprising, upon determining that the overclocking entry or exit criteria are satisfied, waiting for a predetermined amount of time prior to beginning or discontinuing the overclocking, respectively.

10. The method of claim 9, wherein the predetermined amount of time is computed based at least in part upon a moving average.

11. The method of claim 5, further comprising in response to determining that a first core in the device is to be overclocked, increasing the voltage of the first core prior to it being overclocked.

12. The method of claim 5, wherein the overclocking exit criteria are satisfied when one of the overclocked cores exceeds a maximum permitted overclocking temperature or when all of the cores exceed a maximum permitted total power consumption.

13. An apparatus, comprising:
a plurality of processing cores;
a performance control unit configured to automatically determine, from current apparatus state information, whether to overclock one or more of the plurality of processing cores.

14. The apparatus of claim 13, wherein the current apparatus state information includes one or more temperature values indicative of temperatures within the plurality of processing cores, and wherein the performance control unit is configured to overclock one or more of the plurality of processing cores in response to automatically determining that the temperature values are below a predetermined temperature.

15. The apparatus of claim 14, wherein the current apparatus state information includes power consumption information for the plurality of processing cores, wherein the performance control unit is configured to overclock one or more of the plurality of processing cores in response to automatically determining that the power consumption information is below a predetermined power consumption level.

16. The apparatus of claim 13, wherein the performance control unit is configured to overclock a first of the plurality of processing cores only when the first core is operating at a maximum performance level associated with a non-overclocked state.

17. The apparatus of claim 13, wherein the performance control unit is configured to automatically generate a composite score indicative of thermal operating characteristics of the apparatus, wherein the performance control unit is configured to overclock one or more of the plurality of processing cores based on the score satisfying a predetermined threshold.

18. The apparatus of claim 16, wherein the performance control unit is configured to overclock one or more of the plurality of processing cores in response to automatically determining that current performance levels of at least two cores are separated by a predetermined number of levels.

19. The apparatus of claim 13, wherein the performance control unit is configured to determine whether to overclock based on a) performance state information received from an operating system and b) thermal information received from one or more thermal-sensing devices in the apparatus.

20. The apparatus of claim 13, wherein the performance control unit is configured to send an indication to disable hardware temperature control throttling in response to the performance control unit automatically determining to overclock one or more of the plurality of processing cores.
